(19) United States
(12) Patent Application Publication
(10) Pub. No.: US 2015/0033633 A1
(43) Pub. Date: Feb. 5, 2015

(54) DEVICE FOR COVERING THE LOWER GUIDED CHANNEL OF A DOOR

(71) Applicant: KLEIN IBERICA, S.A., Barcelona (ES)

(72) Inventor: Miguel Angel TARREGA LLORET, Barcelona (ES)

(21) Appl. No.: 14/448,296

(22) Filed: Jul. 31, 2014

Related U.S. Application Data
(60) Provisional application No. 61/860,495, filed on Jul. 31, 2013.

(51) Int. Cl. E06B 7/16; E05D 15/16; E06B 1/70; E05D 15/06

(52) U.S. Cl. CPC E06B 7/16; E05D 15/0686; E05D 15/165; E06B 1/70
USPC 49/406

(57) ABSTRACT

A device for covering the lower guided channel of a door, said door (100) comprising a guided sheet (101) designed to slide along the length of a lower guided channel (102). The device (1) is designed by a strip mechanism (10), linked to the movement of the guided sheet (101), which keeps the lower guided channel (102) covered. The strip mechanism (10) comprises a guide profile (11) designed to adjust in the lower guided channel (102), which has an upper track (12S) and a lower track (12I); a first strip (20A) with a first upper end (21A) that may be connected to a first edge (101A) designed to slide along the upper track (12S), and a lower free end (22A) designed to slide along the lower track (12I); and a first terminal (30A) joined to a first end (13) designed to enable the first strip (20A) to return and slide.

### CROSS-REFERENCE TO RELATED APPLICATIONS

This application claims the benefit of provisional U.S. patent application Ser. No. 61/860,495 filed Jul. 31, 2013, which is incorporated by reference herein.

### DESCRIPTION

1. Field of the Invention

The present invention relates to a device for covering the lower guided channel of a door, said door being of the variety comprising a guided sheet, configured to slide along the length of a lower guided channel, proving particularly ideal for use in sliding and folding doors with sheets of glass.

2. Background of the Invention

Sliding or folding doors prove extremely useful in separating internal spaces within the building sector. The guided sheets thereof are designed to slide along the length of lower guided channels, arranged on the passage surfaces. With the aim of attaining better architectural integration, lower guided channels are usually built into said passage surfaces. These channels usually leave a longitudinal hollow exposed to dirt, which on occasions, may also cause trips or falls. Various devices designed to cover the lower guided channel of a door of the variety described are currently known about.

One of the simplest of these devices consists of arranging two strips of brush opposite one another along the length of the lower guided channel. The flexible filaments thereof cover the longitudinal hollow, whilst also enabling the guided sheet to slide. Nevertheless, this solution does not prevent dust or other small objects from passing through the filaments and remaining at the bottom of the channel, thus making it even more difficult to clean. Likewise, they provide a certain amount of resistance to the movement of the guided sheet, meaning the same is moved jauntily. Furthermore, they are unaesthetic.

Other more complex designs are based on the use of a strip mechanism linked to the movement of the guided sheet, which keeps the internal guided channel closed. In general, the same strip is joined at its ends to both opposite sides of the guided sheet. In order to successfully cover the entire longitudinal hollow, this strip must, in most cases, follow a complicated trajectory via the structure of the guided sheet itself or the structure of the door frame. This means that said devices are particularly designed for sheets made from wood or metal carpentry and are not suitable for glass sheets. Furthermore, said complicated trajectory complicates the manufacture and mounting of the door enormously and furthermore, offers almost no standardization or flexibility in its components, in order for them to be adapted to doors of different sizes and/or configurations. Likewise, the strip usually remains loose in the lower guided channel, without better fixation, thus meaning it may come out of the same or result in empty spaces relative to said channel, which degrade the seal thereof to a certain extent.

The present invention resolves the problems set out above by means of a device designed by a strip mechanism, the configuration of which enables one or more strips, independently of the structure of the guided sheet or doorframe, to be placed optimally, thus making it particularly ideal for use in glass sheets. The shape thereof used to enable said strips to slide guarantees the same operates smoothly and safely, keeping them well fasted to both the lower guided channel and the guided sheet. This gives rise to a highly aesthetic, seal-tight device, which may be easily assembled and disassembled.

### DESCRIPTION OF THE INVENTION

The device of the present invention is especially designed to cover the lower guided channel of a sliding or folding door, said door being of the variety comprising at least one guided sheet, designed to slide along the length of a lower guided channel. Said device is of particular interest in terms of use in guided sheets of glass, of utmost design, aesthetic and practicality, which travel on lower guided channels built into a passage surface. Nevertheless, it may also be used with sheets made from wood or aluminum carpentry and/or in surface mounting channels, wherein the accumulation of dirt is to be avoided.

The device of the present invention is designed by a strip mechanism linked to the movement of the guided sheet, which keeps the lower guided channel covered. Said device is characterized in that the strip mechanism comprises:
a guide profile designed to be adjusted in the lower guided channel, along the length of which the following can be found:
   an upper track
   and a lower track,
a first strip, with:
   a first upper end that may be connected to a first edge of the guided sheet, designed to slide along the upper track,
   a first free lower end, designed to slide along the lower track and
a first terminal joined to a first end of the guide profile, designed to enable the first strip to return and slide.

This basic configuration of the present invention offers a solution to many constructive variations and uses standard basic components that are compatible with a great number of doors of different sizes, which may also/alternatively be easily adapted to the same, in order to facilitate the assembly and installation thereof.

By way of example of a constructive alternative, a sliding door with just one guided sheet is mentioned, which when in open position, is hidden between closures. The lower guided channel stretch arranged on the passage surface is permanently covered by the first strip, whilst the stretch of channel hidden between the closures may remain uncovered.

In addition, the strip mechanism comprises:
a second strip, which has:
   a second upper end that may be connected to a second edge of the guided sheet opposite to the first edge, designed to slide along the upper track
   and a second free lower end, designed to slide along the lower track and
a second terminal joined to a second end of the guide profile opposite the first end, configured to enable the second strip to return and slide.

This specific configuration of the present invention offers a solution to many other constructive alternatives.

By way of example, a sliding door with just one guided sheet is mentioned, which, when in open position, is hidden between closures. The stretch of lower guided channel arranged on the passage surface is permanently covered by the first strip, whilst the stretch of channel hidden between the closures is permanently covered by the second strip. It may generally be applied to any other kind of sliding or folding door, the lower guided channel of which is not hidden between closures.

The guide profile preferably comprises a lower longitudinal wall delimited between two longitudinal side walls, defining a U-shaped cross-section. In order to facilitate the assembly thereof, said guide profile is preferably designed to adjust to pressure in the lower guided channel, although other fixation means for fixing to the channel are also possible, by means of using screws or other mechanical fastening systems. The lower guided channel may particularly be mechanized in order for it to also take on the function of guide profile.

The side walls preferably comprise anchoring elements on their external face, designed to ensure the guide profile is properly fixed in the lower guided channel. These elements may consist in the use of projections and/or prominences, which are adjusted on the corresponding grooves and/or slots, thus enabling the assembly under pressure and disassembly thereof, for example, by means of using tools.

The guide profile preferably comprises upper longitudinal rims, designed to be levelled with a passage surface, the shape and design of which responds to the level of aesthetic finish to be given to the door.

The upper track is preferably delimited by the upper rims and a number of upper ledges, which extend horizontally from the side walls from the internal face thereof. In contrast, the lower track is delimited by the lower wall and lower ledges, which extend horizontally from the side walls from the internal face thereof. This prevents the strip from becoming loose and thus guarantees it is fastened correctly.

The strips are preferably formed by a plate of flexible, resistant material, giving them a finish, color and shape that corresponds to the desired aesthetic, whilst considering the remaining elements of the device, such as the upper rims, for example.

The terminal preferably comprises an internal semi-circular curvature, defined between an upper input point aligned with the upper track and a lower output point, aligned with the lower track. Of the various constructive solutions available, said internal curvature is preferably formed on a rear lid, designed to be coupled to the terminal. In turn, the terminal comprises a roller, arranged between the upper track and the lower track, concentric to the internal curvature, leaving an empty through space between the roller and the internal curvature, in order to enable the strip to return and slide.

According to a preferred embodiment, the terminal is an independent element, i.e. it is separate from the guide profile. This facilitates the in situ assembly thereof, since once the guide profile has been cut according to the dimensions of the lower guided channel, the terminals are connected to one or both ends of the guide profile longitudinally. At the same time, it favors system reversibility, given that alongside the rear lid mentioned above, it makes it possible to tackle any accidental obstruction or repair in the device, without having to disassemble the guided sheet or other structural components of the door. Nevertheless, made to measure solutions might also be considered, where the guide profiles are manufactured in series, the terminals being included as an integrated part of the profile itself by defect.

The present invention considers various possibilities for connecting the steps to the guided sheet.

According to a first connection embodiment, the device comprises a connecting stage, designed to be stuck horizontally under any of the edges of the guided sheet, which is formed by:
a lower plate delimited by two lower parallel wings
and a flexible connection bar, which extends from the lower plate, the end of which has a hook designed to be connected to any of the upper ends.

Therefore, the first upper end comprises a first connector element designed to be joined to the hook, whilst the second upper end comprises a second connector element, designed to be joined to said hook.

According to a second connection embodiment, the device comprises a connector mechanism designed to be stuck vertically to any of the edges of the guided sheet, which is formed by:
a hollow side piece delimited by two parallel side wings, with a groove in its external face
and a fastener, formed by:
   an external stretch designed to be connected to any of the upper ends
   and an internal stretch designed to slide within the hollow side piece, which has a pivot designed to slide along the groove in order to connect or disconnect the external stretch to/from the upper end.

The fastener may be flat in section, for thinner, more compact connector mechanisms, which have either a cylindrical or multi-faceted section for larger mechanisms.

### BRIEF DESCRIPTION OF THE DRAWINGS

Below is a very brief description of a series of drawings which facilitate a better understanding of the invention and are expressly related to an embodiment of said invention, presented as a non-limiting example of the same.

FIG. 1 is a perspective view of the lower portion of a sliding door with the device of the present invention.

FIG. 2 is a profile view in detail of the door shown in FIG. 1.

FIG. 3 is a sectioned view according to the cut line A-A shown in FIG. 2.

FIG. 4 is a sectioned view according to the cut line B-B shown in FIG. 3.

FIG. 5 is a perspective view of the guide profile.

FIG. 6 is a profile view of the guide profile.

FIG. 7 is a perspective view of a terminal.

FIG. 8 is a side view of a terminal.

FIG. 9 is a profile view of a terminal.

FIG. 10 is a sectioned view according to the cut line C-C shown in FIG. 8.

FIG. 11 is a lower detailed perspective view of the connection between a strip and an edge of the guided sheet, according to a first connection embodiment.

FIG. 12 is a side detailed view of the connection between a snip and an edge of the guided sheet, according to a first connection embodiment.

FIG. 13 is a lower detailed perspective view of the connection between a strip and an edge of the guided sheet, according to a second connection embodiment.

FIG. 14 is a lower detailed perspective view of the connection between a strip and an edge of the guided sheet, according to an alternative of the second connection embodiment.

### DETAILED DESCRIPTION OF THE INVENTION

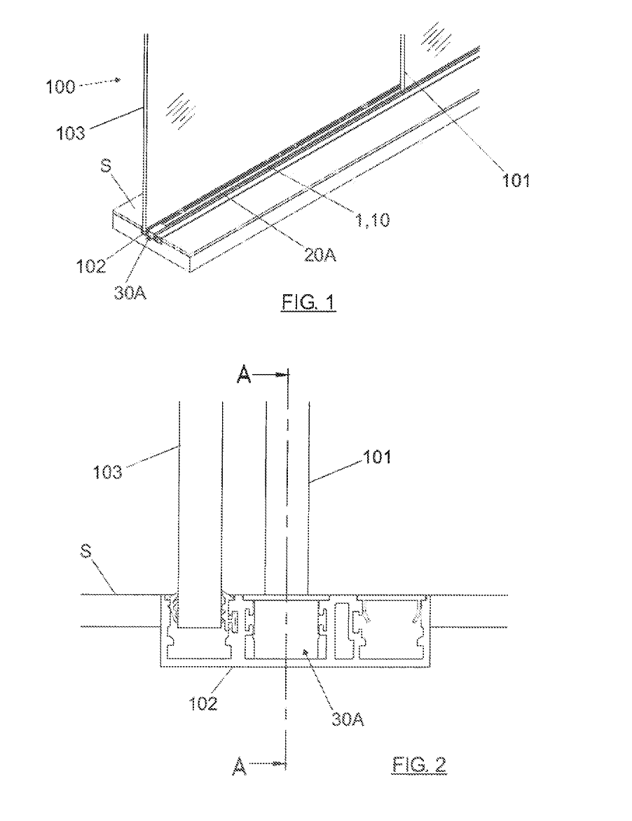

FIGS. 1 to 4 are various views of the lower portion of a sliding door (100), with the device (1) of the present invention. As can be observed, the door (100) is of the variety comprising at least one guided sheet (101), designed to slide along the length of a lower guided channel (102). According to the present example, the lower guided channel (102) is built into a passage surface (S). In turn, the door (100) furthermore comprises a fixed sheet (103), both sheets (101, 103) being made of glass.

The device (1) of the present invention is designed by a strip mechanism (10) linked to the movement of the guided sheet (101), which keeps the lower guided channel (102) covered. Said device (1) is characterized in that the strip mechanism (10) comprises:
a guide profile (11), designed to be adjusted on the lower guided channel (102), which has the following along its length:
   an upper track (12S)
   and a lower track (12I)
a first strip (20A), which has:
   a first upper end (21A) that may be connected to a first edge (101A) of the guided sheet (101) designed to slide along the upper track (12S)
   and a first free lower end (22A), designed to slide along the lower rack (12I) and
a first terminal (30A), joined to a first end (13) of the guide profile (11), designed to enable the first strip (20A) to return and slide.

According to the present example, the strip mechanism (10) comprises:
a second strip (20B), which has:
   a second upper end (21B) that may be connected to a second edge (101B) of the guided sheet (101) opposite to the first edge (101A), designed to slide along the upper track (12S)
   and a second free lower end (22B), designed to slide along the lower track (12I) and
a second terminal (30B) joined to a second end (14) of the guide profile (11) opposite the first end (13), designed to enable the second strip (20B) to return and slide.

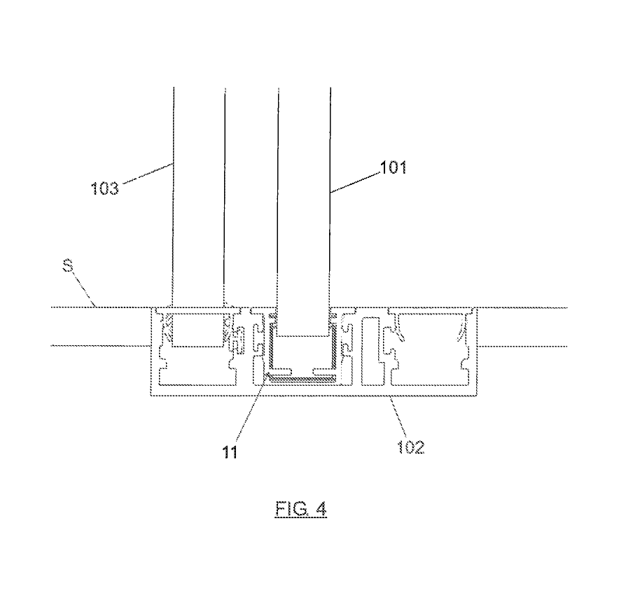

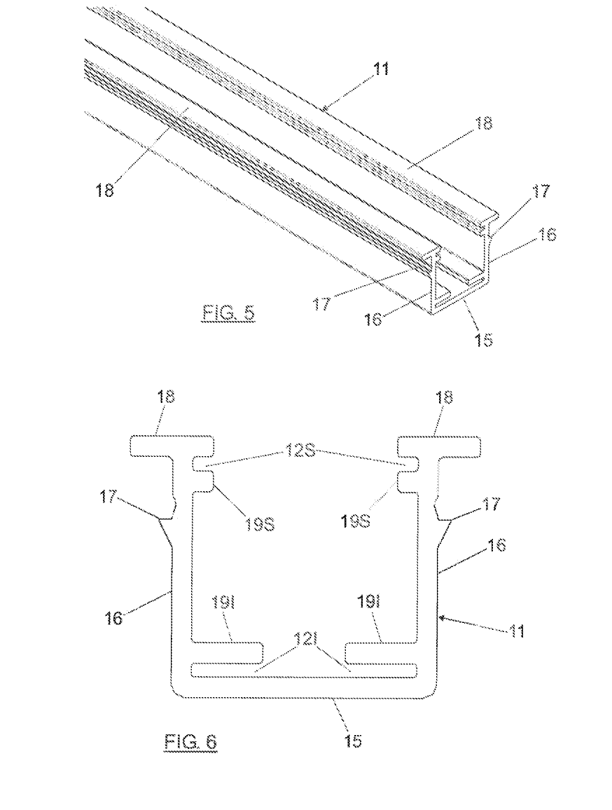

FIGS. 5 and 6 are respective perspective and profile views of the guide profile (11). As can be observed, the guide profile (11) comprises a lower longitudinal wall (15) delimited between two longitudinal side walls (16), defining a U-shaped cross-section. In order to facilitate the assembly thereof, said guide profile (11) is designed to adjust to pressure in the lower guided channel (102), FIG. 4.

As can be observed, the side walls (16) comprise anchoring elements (17) on their external face, which are designed to ensure the guide profile (11) is properly fixed in the lower guided channel (102). Likewise, the guide profile (11) comprises upper longitudinal rims (18), designed to be leveled with a passage surface (S), FIG. 4, the shape and design of which correspond to the level of aesthetic finish to be given to the door (100).

As can be observed, the upper track (12S) is delimited by the upper rims (18) and upper ledges (19S), which extend horizontally from the side walls (16) from the internal face thereof. Meanwhile, the lower track (12I) is delimited by the lower wall (15) and lower protrusions (19I), which extend horizontally from the side walls (16) from the internal face thereof.

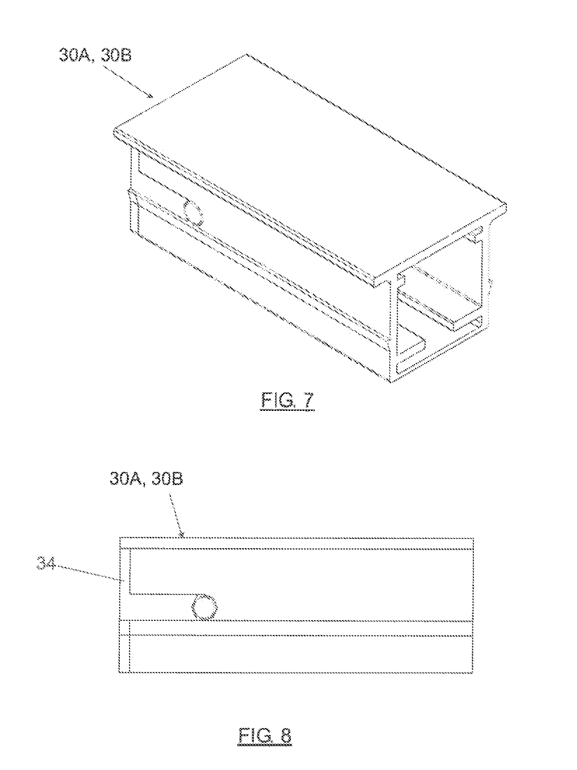

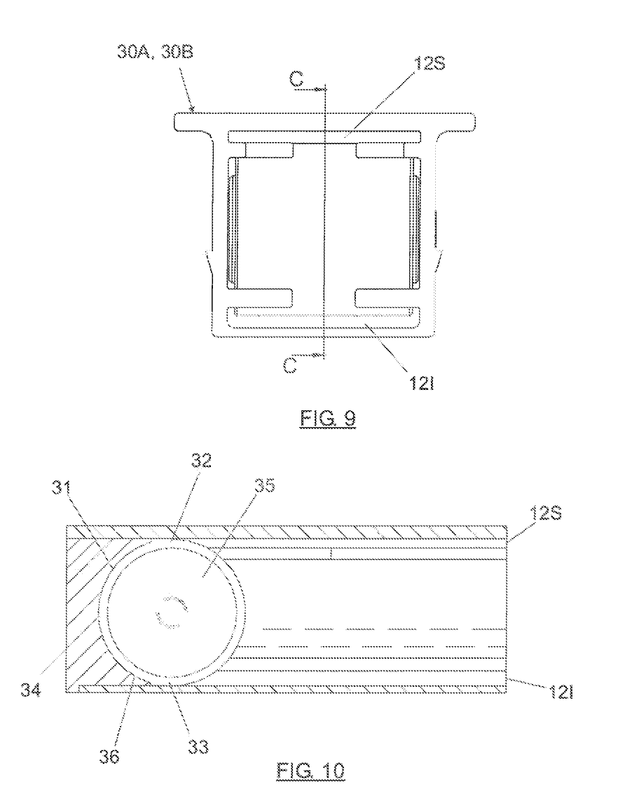

FIGS. 7 to 10 provide various views of a terminal (30A, 30B). As can be observed, the terminal (30A, 30B) comprises an internal semi-circular curvature (31) defined between an upper input point (32) aligned with the upper track (12S) and a lower output point (33), aligned with the lower track (12I). According to the present example, said internal curvature (31) is formed on rear lid (34), configured to be coupled to the terminal (30A, 30B). In turn, the terminal (10A, 30B) comprises a roller (35) arranged between the upper track (12S) and the lower track (12I), concentric to the internal curvature (31), thus leaving an empty through space (36) between the roller (35) and internal curvature (31), in order to enable the strip (20A, 20B), which is not shown in these figures in order to provide greater visual clarity, to return and slide.

According to the present example, the terminal (30A, 30B) is an independent element, separated from the guide profile (11).

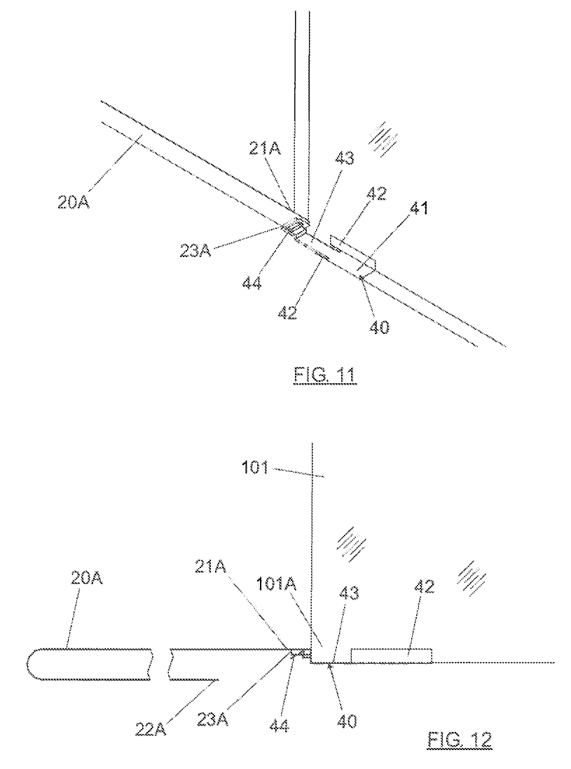

FIGS. 11 and 12 are respective lower and detailed perspective side views of the connection of the first strip (20A) to the first edge (101A) of the guided sheet (101), according to a first connection embodiment. In order to provide greater visual clarity, neither the guide profile (11), the lower guided channel (102) nor the first terminal (30A) have been represented. It is possible to observe that the connection between the second strip (20B) and the second edge (101B) of the guided sheet (101) is identical, taking the symmetry of the device (1) into account.

As can be observed, the device (1) comprises a connecting stage (40) designed to be stuck horizontally under the first edge (101A) of the guided sheet (101), which is formed by:
a lower plate (41) delimited by two lower parallel wings (42)
and a flexible connection bar (43), which extends from the lower plate (41), the end of which has a hook (44), designed to be connected to the first upper end (21A).

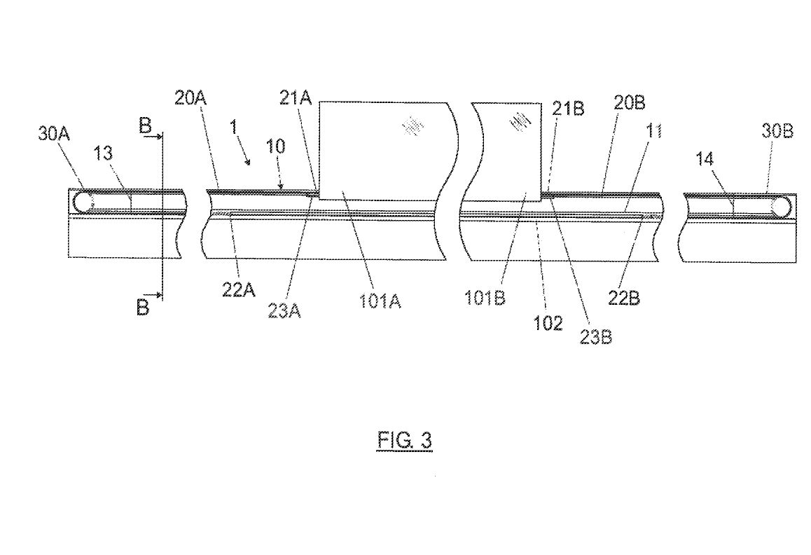

Therefore, the first upper end (21A) comprises a first connector element (23A), designed to be joined to the hook (44). In FIG. 3, it is also possible to observe that the second upper end (21B) comprises a second connector element (23B), designed to be joined to said hook (44).

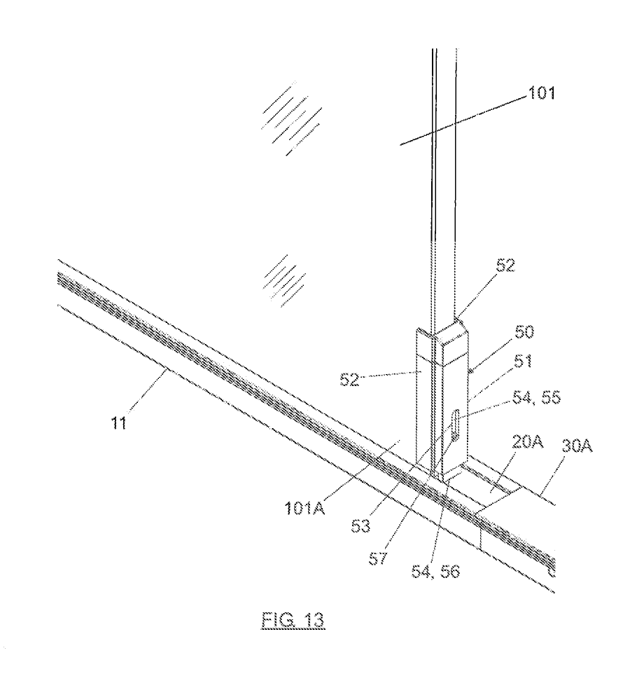

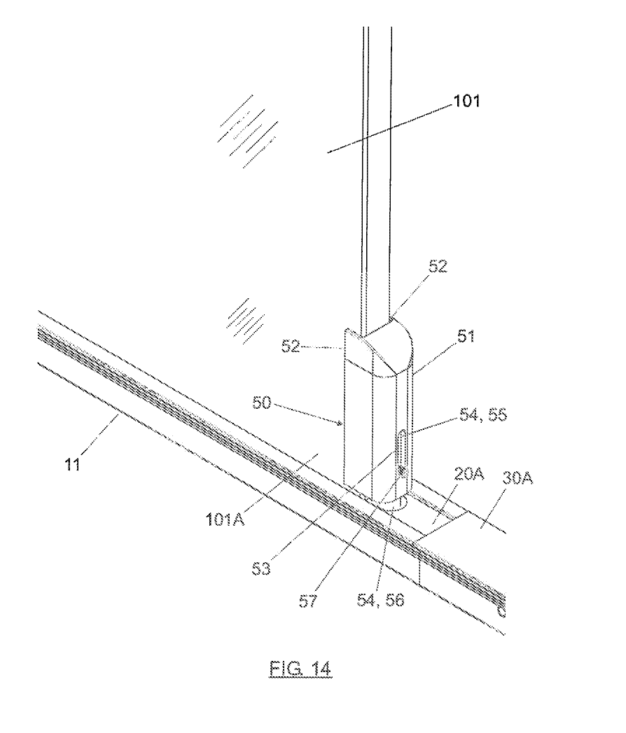

FIGS. 13 and 14 provide a lower detailed perspective view of the connection between the first strip (20A) and the first edge (101A) of the guided sheet (101), according to a second connection embodiment and a variant of the same. In order to provide greater visual clarity, the lower guided channel (102) has not been represented. It is possible to observe that the connection between the second strip (20B) and the second edge (101B) of the guided sheet (101) is identical, taking the symmetry of the device (1) into account.

As can be observed, the device (1) comprises a connector mechanism (50), designed to be stuck vertically to the first edge (101A) of the guided sheet (101), which is formed by:
a hollow side piece (51) delimited by two parallel side wings (52), with a groove (53) on the external face thereof
and a fastener (54) formed by:
   an external stretch (55) designed to be connected to the first upper end (21A)
   and an internal stretch (56) designed to slide within the hollow side piece (51), which has a pivot (57) designed to slide along the groove (53), in order to connect or disconnect the external stretch (55) to/from the first upper end (21A).

The fastener (54) shown in FIG. 13 is flat, whilst the fastener (54) in FIG. 14 is cylindrical.

1. A device for covering the lower guided channel of a door, said door being of the variety comprising a guided sheet designed to slide along the length of a lower guided channel, where said device is designed by a strip mechanism, linked to the movement of the guided sheet, which keeps the lower guided channel covered, wherein the strip mechanism comprises:
a guide profile designed to adjust in the lower guided channel, which has the following along its length:
an upper track,
and a lower track,
a first strip, which has:
a first upper end that may be connected to a first edge of the guided sheet, designed to slide along the upper track,
and a lower free end, designed to slide along the lower track, and
a first terminal joined to a first end of the guide profile, designed to enable the first strip to return and slide.

2. The device for covering the lower guided channel of a door according to claim 1, wherein the strip mechanism comprises:
a second strip, with:
a second upper end that may be connected to a second edge of the guided sheet opposite to the first edge configured to slide along the upper track,
and a second lower free end, designed to slide along the lower track, and
a second terminal) joined to a second end of the guide profile opposite the first end, designed to enable the second strip to return and slide.

3. The device for covering the lower guided channel of a door according to claim 1, wherein the guide profile comprises a lower longitudinal wall delimited between two longitudinal side walls, defining a U-shaped cross-section, said guide profile is designed to adjust to pressure in the lower guided channel.

4. The device for covering the lower guided channel of a door according to claim 3, wherein the side walls comprise anchoring elements on their external face, configured to ensure the guide profile is fixed to the lower guided channel.

5. The device for covering the lower guided channel of a door according to claim 1, wherein the guide profile comprises upper longitudinal rims, designed to be leveled with the passage surface.

6. The device for covering the lower guided channel of a door according to claim 3, wherein the upper track is delimited by the upper rims and upper ledges, which extend horizontally from the side walls from the internal face thereof.

7. The device for covering the lower guided channel of a door according to claim 3, wherein the lower track is delimited by the lower wall and lower ledges, which extend horizontally from the side walls from the internal face thereof.

8. The device for covering the lower guided channel of a door according to claim 2, wherein each of the first and second terminal comprises an internal semi-circular curvature defined between an upper input point, aligned with the upper track and a lower output point aligned with the lower track.

9. Device for covering the lower guided channel of a door according to claim 8, wherein the internal curvature is formed on a rear lid, designed to be coupled to each of the first and second terminal.

10. Device for covering the lower guided channel of a door according to claim 8, wherein each of the first and second terminal comprises a roller arranged between the upper track and the lower track, concentric to the internal curvature, thus leaving an empty through space between the roller and the internal curvature, in order to enable each of the first and second strip to return and slide.

11. The device for covering the lower guided channel of a door according to claim 2, wherein it comprises a connecting stage, designed to be stuck horizontally under any of the first and second edges of the guided sheet, which is formed by:
a lower plate delimited by two lower parallel wings
and a flexible connection bar, which extends from the lower plate, the end of which has a hook, designed to connect to any of the first and second upper ends.

12. The device for covering the lower guided channel of a door according to claim 11, wherein the first upper end comprises a first connector element designed to be joined to the hook.

13. The device for covering the lower guided channel of a door according to claim 11, wherein the second upper end comprises a second connector element, configured to be joined to the hook.

14. The device for covering the lower guided channel of a door according to claim 2, wherein it comprises a connector mechanism configured to be stuck vertically to any of the first and second edges of the guided sheet, which is formed by:
a hollow side piece, delimited by two parallel side wings, with a groove in the external face thereof,
and a fastener formed by:
an external stretch configured to be connected to any of the first and second upper ends,
and an internal stretch configured to slide inside the hollow side piece, which has a pivot, designed to slide along the groove, in order to connect or disconnect the external stretch to/from each of the first and second upper end.
